(19) United States
(12) Patent Application Publication
(10) Pub. No.: US 2023/0298079 A1
(43) Pub. Date: Sep. 21, 2023

(54) ACCESS CONTROL SYSTEM PROTECTING PRODUCTS AT DIFFERENT VENDOR LOCATIONS BASED ON LOCALLY PROVIDED IDENTIFICATION DOCUMENTS AND CENTRALLY MANAGED BANNED USER DATA

(71) Applicant: Servall Data Systems Inc., Calgary (CA)

(72) Inventors: Alberio Bathory-Frota, Calgary (CA); James Edward Marusiak, Sanford, FL (US)

(21) Appl. No.: 17/694,839

(22) Filed: Mar. 15, 2022

(51) Int. Cl. G06Q 30/06; G07C 9/00

(52) U.S. Cl. CPC G06Q 30/0609; G07C 9/00182; G07C 9/00571; G06Q 30/0607

(57) ABSTRACT

An access control system includes identification document scanners installed at multiple vendor locations. A first local controller at a first vendor location by default controls one or more lock actuators to be in a locked configuration. An identification document scanner scans an identification document provided by a user at the first vendor location. The first local controller validates whether the identification document is authentic and passes user information obtained from the identification document to a central controller. The first local controller then controls one or more of the lock actuators to temporarily enter an unlocked configuration and thereby grant the user access to one or more products in response to determining that the identification document is authentic and receiving a ban status from a central controller indicating that the user is not banned for access. An access history log allows vendor staff to view access attempts and ban users.

### BACKGROUND OF THE INVENTION

### (1) Field of the Invention

The invention pertains generally to protecting products from theft at vendor locations such as convenience stores, liquor stores and the like. More specifically, the invention relates to providing access control by automatically unlocking physical access to products after successfully authenticating locally provided identification documents provided by users and confirming with a central controller that user information obtained from said documents does not correspond to a known banned user.

### (2) Description of the Related Art

Vendors such as convenience stores, liquor stores and the like often experience theft from customers. To avoid violence and abuse of people in the store, these types of vendors often enact “no engage” policies, which instruct staff to take no intervening action in the event theft is observed. If someone in the store notices a theft occurring, staff are trained to simply get themselves and other customers out of the way and allow the thief to exit the premises with whatever product they can carry. After the thief has left, staff report the theft to the vendor's security team, which is typically located offsite and notified by telephone. The security team has remote access to video and audio recordings from the store to investigate and report the crime to police.

Although “no engage” policies do reduce violence, these policies embolden criminals to return to the store again and again as free product is virtually guaranteed at little risk. Allowing thieves to take whatever product they want also increases costs for the store and/or the store's insurance company.

For more than a year before the filing of the present patent application, Servall Data Systems Inc. has deployed a system to decrease theft from liquor stores utilizing a system similar to how bank's increase security of publicly-accessible areas after hours.

Banks often increase after-hours-security of rooms containing automated teller machines (ATMs) by requiring customers to provide a valid bank card before allowing the customer to enter the ATM room. A card reader mounted adjacent to the bank's door is used to read the magnetic strip or RFID chip of a customer bank card. The door automatically unlocks when the inserted card is a valid bank card.

Rather than checking for a valid bank card before allowing entry, Servall's liquor store access control system checks for a valid identification document such as a driver's license or passport before allowing entry to the store. These are the same types of document that a person buying liquor needs to show to verify age. An identification document scanner is mounted adjacent a liquor store door and a person desiring entry scans their ID in the scanner. The scanner automatically determines whether the ID card is valid and, when yes, unlocks the door. Otherwise, if the ID is not valid, the door remains locked and the person is unable to enter the liquor store.

Although this liquor store access control system has reduced theft at liquor stores by keeping people unwilling or unable to show photo ID from entering the store, the solution is not ideal, especially for other types of stores such as convenience stores. Convenience stores often sell many different types of products where only some products such as cold beer and wine require photo ID. Blocking all customers who don't have valid ID from the store would hurt business. Furthermore, simply checking for valid ID at the door does not reduce theft in cases where a criminal shows valid ID in order to enter the store. With Servall's currently-deployed liquor store access control system, there is nothing stopping a criminal from either utilizing their own valid photo ID or someone else's stolen ID in order to gain entry. Once in the store, the thief may take whatever product they want without challenge as a result of typical “no engage” policies implemented at the store. Likewise, with Servall's deployed liquor store access control system, there is nothing stopping the thief from returning again and again to the same store or from going to different stores in the local area to perform a similar crime, even if the criminal uses the same identification document to gain access each time.

### BRIEF SUMMARY OF THE INVENTION

According to an exemplary embodiment of the invention there is disclosed an access control system including an identification document scanner installed at a first vendor location, one or more lock actuators installed at the first vendor location, a first local controller installed at the first vendor location and coupled to the identification document scanner and the one or more lock actuators, and a central controller coupled by an external computer network to a plurality of local controllers at a plurality of different vendor locations, the plurality of local controllers including the first local controller at the first vendor location. The first local controller by default controls the one or more lock actuators to be in a locked configuration. The identification document scanner is configured to scan an identification document provided by a user at the first vendor location. The first local controller is configured to validate whether the identification document is authentic and to pass user information obtained from the identification document to the central controller. The central controller is configured to determine whether the user information corresponds to a known user who has been banned for access and to pass a ban status for the user back to the first local controller. The first local controller is configured to control one or more of the lock actuators to temporarily enter an unlocked configuration and thereby grant the user access to one or more products secured by the one or more of the lock actuators in response to determining that the identification document is authentic and receiving the ban status from the central controller indicating that the user is not banned for access.

According to an exemplary embodiment of the invention there is disclosed a local controller installed at a first vendor location. The local controller includes one or more communication interfaces for coupling to an identification document scanner installed at the first vendor location, one or more lock actuators installed at the first vendor location, and a central controller coupled to the local controller by an external computer network. The local controller further includes one or more storage devices and one or more processors coupled to the one or more communication interface and the one or more storage devices. By the one or more processors executing a plurality of software instructions loaded from the one or more storage devices, the one or more processors are configured to, by default, control the one or more lock actuators to be in a locked configuration. The one or more processors are further configured to receive scan data from the identification document scanner of a scan of an identification document provided by a user and validate whether the identification document is authentic. The one or more processors are further configured to pass one or more user information obtained from the identification document to the central controller and receive a ban status for the user back to the first local controller, the ban status indicating whether the user information corresponds to a known user who is banned for access. The one or more processors are further configured to control one or more of the lock actuators to temporarily enter an unlocked configuration and thereby grant the user access to one or more products secured by the one or more of the lock actuators in response to determining that the identification document is authentic and receiving the ban status from the central controller indicating that the user is not banned for access.

According to an exemplary embodiment of the invention there is disclosed a method of performing access control at a first vendor location. The first vendor location has installed thereat an identification document scanner, one or more lock actuators, and a first local controller being coupled to the identification document scanner and the one or more lock actuators. The method includes, by default, controlling the one or more lock actuators to be in a locked configuration and scanning, by the identification document scanner, an identification document provided by a user at the first vendor location. The method further includes validating, by the first local controller, whether the identification document is authentic and passing user information obtained from the identification document to a central controller. The central controller is coupled by an external computer network to a plurality of local controllers at a plurality of different vendor locations, the plurality of local controllers including the first local controller at the first vendor location. The method further includes determining, by the central controller, whether the user information corresponds to a known user who has been banned for access and passing a ban status for the user back from the central controller to the first local controller. The method further includes controlling, by the first local controller, one or more of the lock actuators to temporarily enter an unlocked configuration and thereby grant the user access to one or more products secured by the one or more of the lock actuators in response to determining that the identification document is authentic and receiving the ban status from the central controller indicating that the user is not banned for access.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 shows an access control system according to an exemplary embodiment.

FIG. 2 shows a cooler having a plurality of doors storing various chilled drink products at one of the vendor locations according to an exemplary embodiment.

FIG. 3 illustrates a cross-sectional plan view of a door lock actuator in a locked configuration according to an exemplary embodiment.

FIG. 4 illustrates a cross-section plan view of the door lock actuator of FIG. 3 in an unlocked configuration according to an exemplary embodiment.

FIG. 5 is a block diagram of the local controller according to an exemplary embodiment.

FIG. 6 shows a flowchart of a method of performing access control at a vendor location according to an exemplary embodiment.

FIG. 7 illustrates an access history log user interface (UI) screen for a particular vendor location according to an exemplary embodiment.

### DETAILED DESCRIPTION

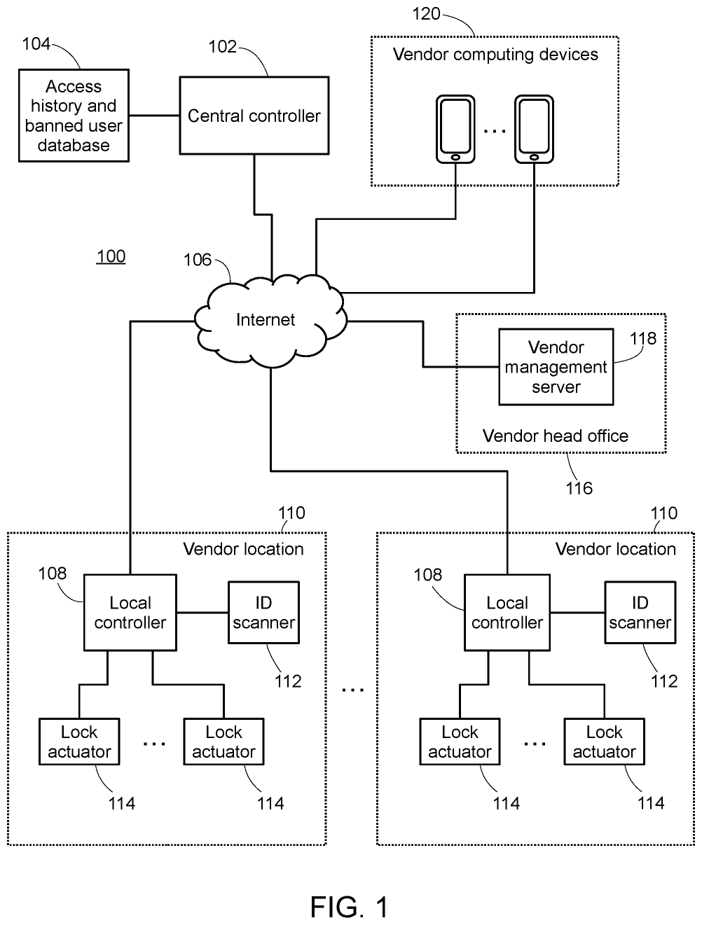

FIG. 1 shows an access control system 100 according to an exemplary embodiment. The system 100 includes a central controller 102 managing an access history and banned user database 104. The central controller 102 is coupled via an external network such as the Internet 106 to a plurality of local controllers 108, which are installed at various vendor locations 110. In one example application, the vendor locations 110 are convenience stores at different physical locations distributed throughout one or more cities. At each vendor location 110, the local controller 108 is coupled to an identification (ID) scanner 112 and one or more lock actuators 114. At the vendor's head office 116, a vendor management computer server 118 is coupled to the central controller 102 via the Internet 106. Mobile phone or other computing devices 120 utilized by vendor employees such as store staff and management personnel are also coupled to the central controller 102 via the Internet 106.

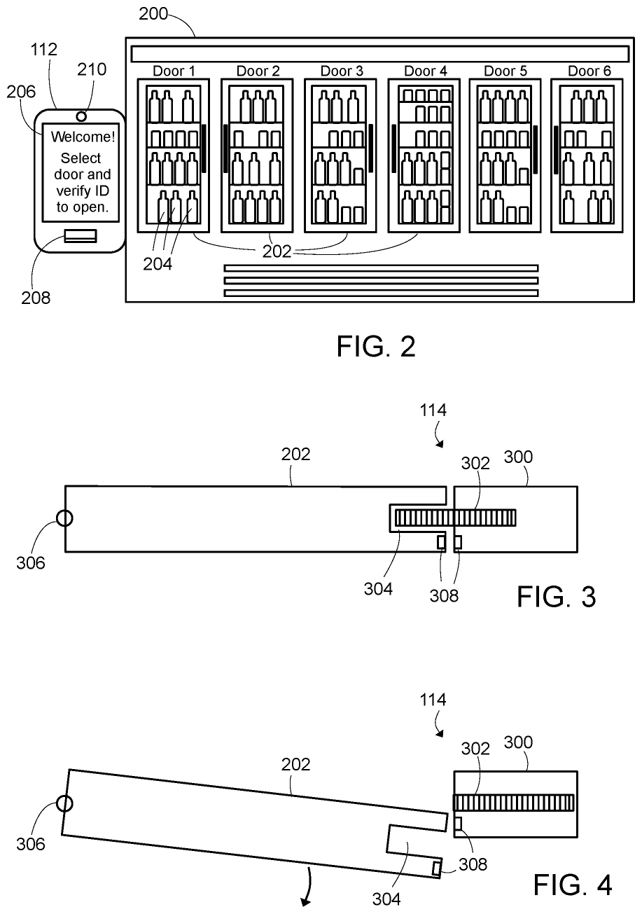

FIG. 2 shows a cooler 200 having a plurality of doors 202 storing various chilled drink products 204 at one of the vendor locations 110 according to an exemplary embodiment. The ID scanner 112 is mounted adjacent to the cooler 200 and includes a touchscreen 206 display to both provide instructions to and receive input from customers at the store 110. The ID scanner 112 enclosure in this embodiment includes the local controller 108 and each of the various doors 202 are locked and unlocked under remote control of the local controller 110. By default, the cooler doors 202 are locked. In order to open a door 202 to obtain a desired drink product 204, a customer needs to place an identification document in the card reader area 208 of the ID scanner 112 and then select the door 202 number to unlock. A camera 210 may be included on the ID scanner 114 to take a picture or video of the person attempting to gain access. A similar cooler 200 or multiple of such coolers 200 with integrated ID scanner 112 may be installed at multiple of the vendor locations 110 throughout the system 100.

FIG. 3 illustrates a cross-sectional plan view of a door lock actuator 114 in a locked configuration according to an exemplary embodiment. In this embodiment, the cooler door 202 includes a linear actuator 300 that engages a locking bolt 302 within a notch 304 on the door 202. When engaged in this manner, the locking bolt 302 prevents the door 202 from rotating around the hinge 306 to open. One or more door sensors 308 pass signals back to the local controller 108 to inform the local controller 108 on the door state being open or closed.

FIG. 4 illustrates a cross-section plan view of the door lock actuator 114 of FIG. 3 in an unlocked configuration according to an exemplary embodiment. To unlock the door 202, the linear actuator 300 disengages (i.e., retracts) the locking bolt 302 from the notch 304 thereby freeing the door 202 to swing open.

Each of the cooler doors 202 in this embodiment has a respective lock actuator 114 including a linear actuator 300 driven by a respective control signal supplied by the local controller 108. The control signals are digital signals outputted by the local controller 108, which feed one or more relays (not shown) to supply proper power levels to the linear actuator 300 to either extend or retract the locking bolt 302. In this embodiment, by default, the lock actuators 114 are controlled by the local controller 108 to be in the locked configuration. In this way, the cooler doors 202 cannot be opened and the drink products 204 stored therein are protected. Only upon active control by the local controller 108 are the lock actuators 114 commanded to change into the unlocked configuration.

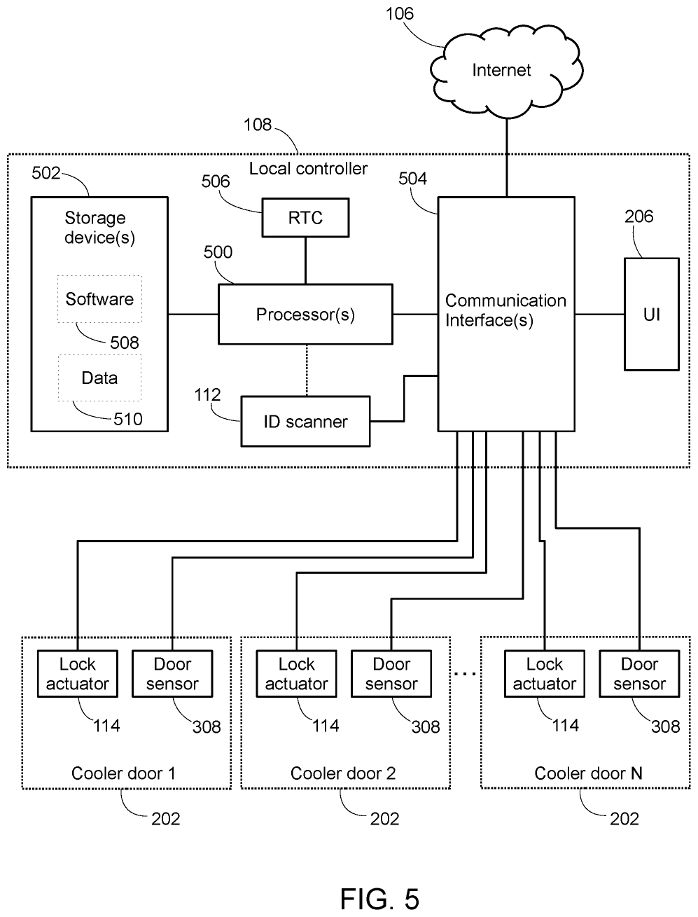

FIG. 5 is a block diagram of the local controller 108 according to an exemplary embodiment. The local controller 108 includes one or more processors 500 coupled to one or more storage device(s) 502 and communication interface(s) 504. A real time clock (RTC) chip 506 is also coupled to the processors 500 and the ID scanner 112, UI touchscreen display 206, and a set of lock actuator 114 and door sensor 308 for each of the N (e.g., six) cooler doors 202 are coupled to the processors 500 via the communication interfaces 504.

One example of communication interfaces 504 include Ethernet transceivers and/or Wi-Fi transceivers allowing the processors 500 to communicate with other devices over external networks such as the Internet 106. Another example communication interface 504 includes universal serial bus (USB) for communicating with the sensors 308 and actuators 114, and a high-definition multimedia interface (HDMI) driver chip for communicating with the UI display 206. As denoted in FIG. 5, in some embodiments, the ID scanner 114 and the local controller 108 are integrated together in the same embedded computing device and the processors 500 may be coupled directly to the ID scanner 112 such as using a bus or other internal communication interface of the processors 500.

The one or more processors 500 may be included in a central processor unit (CPU) of an embedded computing device acting as the local controller 108. In the following description the plural form of the word “processors” will be utilized as it is common for a CPU of an embedded computing device to have multiple processors 500 (sometimes also referred to as cores); however, it is to be understood that a single processor 500 may also be configured to perform the described functionality in other implementations.

Examples of the one or more storage devices 502 include random access memory (RAM) and FLASH storage devices. The storage devices 502 store both software instructions 508 for execution by the processors 500 along with data 510 utilized by the processors 500 when executing the software.

The central controller 102 may also be implemented by a computing device such as a computer server having one or more processors coupled to one or more storage devices storing software and data, and further coupled to one or more communication interfaces such as Ethernet transceiver coupled to the Internet. The access history and banned user database 104 may be stored in one of the storage devices of the central controller 102. In this embodiment, a relational database is utilized to store the access history and banned user database 104; however, the term “database” as utilized in this description is meant to refer to any stored collection of organized data. Again, in the following description the plural form of the word “processors” will be utilized as it is common for a CPU of computer server to have multiple processors (sometimes also referred to as cores); however, it is to be understood that a single processor may also be configured to perform the described functionality in other implementations.

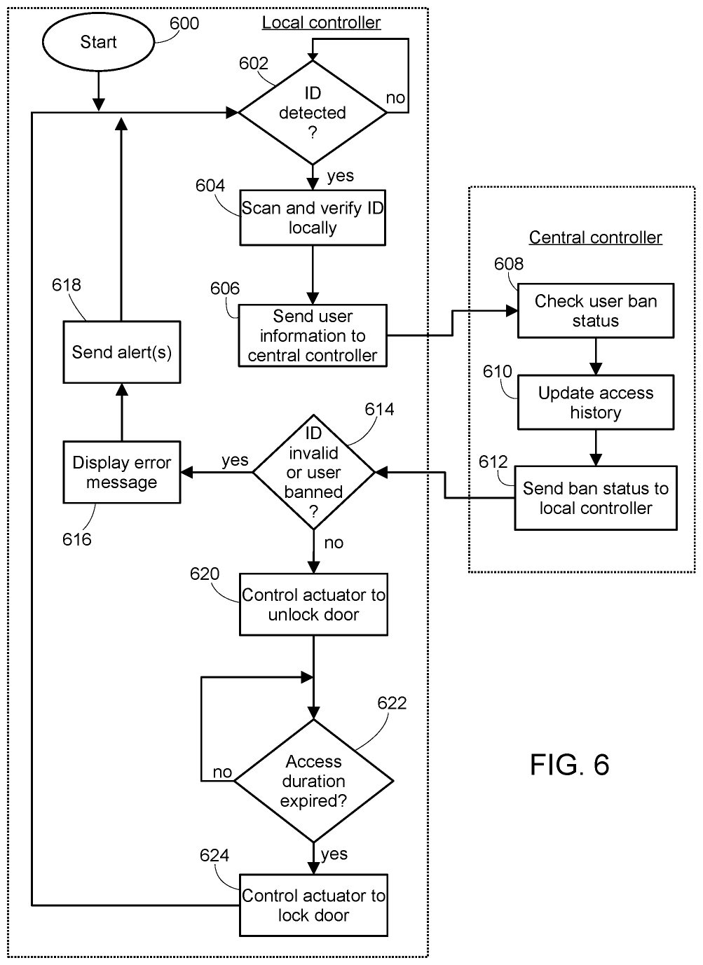

FIG. 6 shows a flowchart of a method of performing access control at a vendor location 110 according to an exemplary embodiment. The steps of FIG. 6 may be performed by processors 500 of the local controller and the processors of the central controller 102 as indicated. The steps of the flowchart are not restricted to the exact order shown, and, in other configurations, shown steps may be omitted or other intermediate steps added.

The process begins at step 600, which essentially designates the starting point in a loop. The starting point may correspond to the local controller 108 powering up such that, as long as power is available within the vendor location 110, the local controller 108 will control access to the cooler 200 contents by dynamically unlocking the cooler doors 202 utilizing the process depicted in the flowchart. As previously described, the default door 202 lock condition in this embodiment is that the local controller 108 drives all lock actuators 114 to be in the locked configuration except when specifically unlocked as described below. To initialize the default condition, at step 600, the local controller may send the appropriate control signals to the one or more lock actuators 114 thereby causing the lock actuators 114 to enter the locked configuration.

At step 602, the local controller 108 detects whether an identification document has been placed onto the scanner platform (i.e., within the card scanner area 208). When yes, control proceeds to step 604; otherwise, control stays at step 602 until an identification document is detected.

At step 604, the ID scanner 112 and/or local controller 108 scans and verifies whether the identification document is valid. Step 604 may be implemented using known techniques such as, for example, those described in United States Patent Application Publication No. 20210004581 published on Jan. 7, 2021 and entitled “APPARATUS, SYSTEM AND METHOD FOR AUTHENTICATING IDENTIFICATION DOCUMENTS”, which is incorporated herein by reference and hereinafter referred to as “the '581 application”.

At step 606, the local controller 108 sends user information obtained from the identification document during step 604 to the central controller 102. Examples of user information include the name of the individual, the birthday of the individual, unique identification numbers associated with the individual (e.g., driver's license number, passport number, etc.). This information may be obtained by the ID scanner 112 and/or local controller 108 applying an optical character recognition algorithm to scanned images of the identification document or may be obtained by decoding barcodes, QR codes, or other digital data provided by the document itself such as using RFID. The user information sent to the central controller 102 may also include the results of whether or not the identification document was determined by ID scanner 112 and/or local controller 108 to be valid.

At step 608, the central controller checks the banned user portion of the database 104 in order to determine whether the user information received from the local controller 108 corresponds to a known user who has been banned for access. For instance, known bad actors who have previously committed theft at any vendor location 110 may be flagged in the banned user database 104 as banned users. A single user such as an individual person may be associated with a plurality of information and may be matched on the basis of name or any subset of the stored information. In this way, a user who is banned may be recognized on the basis of name and birthday even if they utilize different forms of identification documents. Likewise, image recognition of photos on the card and/or a camera 210 on the ID scanner 114 to take a photo of the user attempting to gain cooler 200 access may also be utilized to help identify users. Again, techniques described in the '581 application may be utilized at step 608 for the central controller 102 to determine whether user information corresponds to a known banned user.

At step 610, the central controller 102 updates the access history portion of the database 104 with a record of the access request by the user. Details that may be stored in the database 104 include the data and time of the access attempt along with an identifier of the specific vendor location 110 and the cooler 200 door 202 number selected by the user, the user information sent to the central controller 102 at step 606 including whether the ID was determined to be valid or not, and the banned user status determined by the central controller 102 at step 608.

At step 612, the central controller 102 passes a ban status for the user as determined at step 608 back down to the same local controller 108 that sent the user information at step 606. If the user information was determined to correspond to a known banned user, the ban status information indicates that the user is banned for access. Otherwise, when the user information is not associated with any known banned user, the ban status information indicates that the user is not banned for access.

At step 614, the local controller 108 determines whether either the ID was determined at invalid at step 604 or the ban status information indicates the user was determined to be a known banned user at step 608. When either of these conditions is true, the local controller 108 will not unlock the cooler door and control proceeds to step 616. Alternatively, when both the ID is valid and the user is not a known banned user, control proceeds to step 620.

At step 616, the local controller 108 displays an appropriate error message on the UI display 206. For example, the error message may indicate a reason for denying access or may simply indicate that access is denied.

At step 618, the local controller 108 (and/or the central controller 102) may send one or more alerts such as SMS, email, or push notifications to mobile or other computing devices 120 utilized by staff or management of the vendor. For instance, a store clerk may receive a notification that a person attempting to gain access to the cold beer cooler 200 was denied access. The alerts may occur substantially in real-time and thereby alert the staff of the presence of a potential problematic customer in the store. Once the alerts are sent, control then loops back to step 602 to wait for a next ID document to be detected.

At step 620, the local controller 108 sends one or more commands to the lock actuator 114 in order to unlock the door 202. In embodiments where the local controller 108 is coupled to a plurality of lock actuators 114, the specific lock actuator 114 may be selected by the local controller 108 according to user input received via the UI 206. In one example, a message on the screen 206 may ask the user to select the cooler door 202 to unlock by pressing a button labelled with the door number or clicking a graphical representation of the desired door 202 to unlock. The local actuator 108 then sends an unlock signal to move the lock actuator 114 into the unlocked configuration. The user can then open the cooler door 202 and remove product 204 for purchase.

At step 622, the local controller 108 determines whether an access duration has expired. In this embodiment, the local controller 108 only unlocks cooler doors for a predetermined access duration such as 30 seconds.

The access duration may only be measured by the local controller 108 when the unlocked door is closed and be automatically paused by the local controller 108 when the door 202 is open. A sensor 308 on the door 202 determines whether the door 202 is open or closed. The local actuator 108 then counts down the access duration being the time that the door 202 is both unlocked and closed. This gives the user time to physically move product within the cooler 200 while the door 202 is open while still allowing them to change their mind and re-open the door 202 after it closes. Essentially, the user is given thirty seconds (or another predetermined access duration) of closed-door-time that the door 202 will remain unlocked and can therefore be freely opened by the user without needing to re-verify their identification document.

At step 624, when the access duration is expired, the local controller 108 sends a lock signal to the move the lock actuator 114 back into the locked configuration thereby securing the product 204 stored within the cooler 200. Control then loops back to step 602 to wait for a next ID document to be detected.

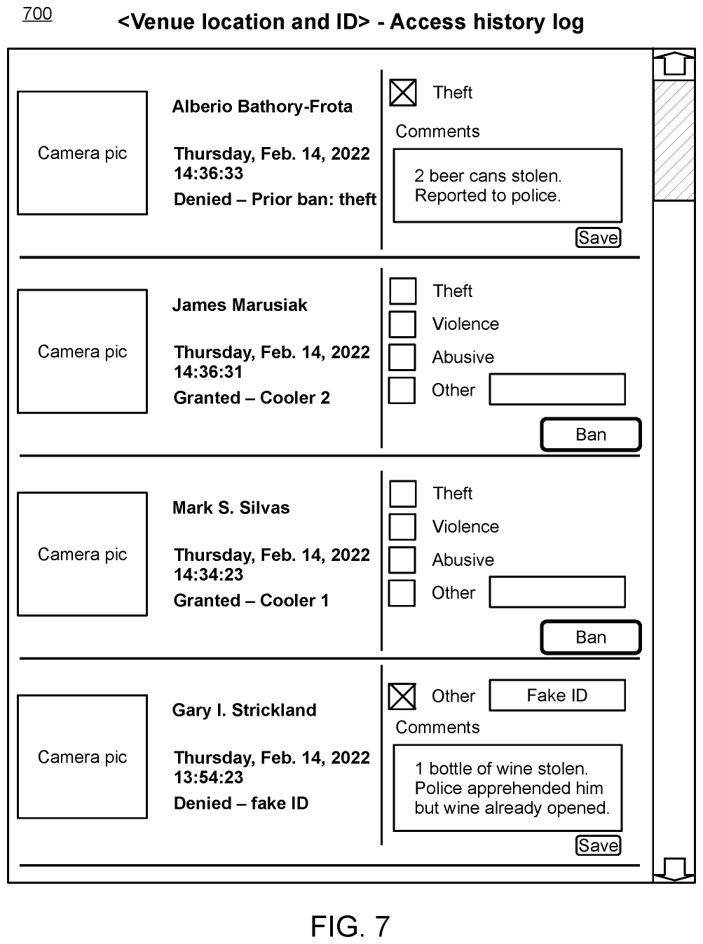

FIG. 7 illustrates an access history log user interface (UI) screen 700 for a particular vendor location according to an exemplary embodiment. The UI screen 700 of FIG. 7 may be generated by a webserver program running on the central controller 102 and accessed by one or more of the vendor computing devices 120 running a standard web browser. Alternatively, in another example, the UI screen 700 may be generated by the vendor management server 118 accessing an application programming interface (API) of the central controller in order to view the access history log portion of the database 104 and update the banned user portion of the database 104.

The access history log UI screen 700 shows all the access attempts performed by users at a specific vendor location 110. A similar UI screen 700 may be generated for other vendor locations 110 in a similar manner and the desired vendor location 110 may be inputted by management or other vendor staff members such as the security team with proper authority to view the access history log.

The UI screen 700 includes a listing of user information associated with each attempt by a person in the store to verify an identification document and gain access to product 204 inside the cooler 200. User information displayed includes any of the user information sent by the local controller 108 to the central controller 102 at step 606 along with information about the ban status of the user as determined by the central controller 102 at step 608 (i.e., at the time of the access attempt). The action taken by the local controller 108 either granting access to a particular cooler door 202 number or denying access and the reason for the denial are also displayed.

The order of records by default is by data and time and switchable between descending or ascending order to help make it easier for the security team or other vendor staff to correlate the displayed information with other security records such video and audio recordings taking within the store (i.e., vendor location 110).

In addition to displaying the access history log, the UI screen 700 further allows management to enter and update comments regarding users that were denied access, and to ban users who were granted access but are now deemed unsuitable to be granted access in the future.

An example usage scenario of the access control system 100 in conjunction with the UI screen 700 of FIG. 7 is as follows:

A person enters a convenience store being one of the vendor locations 110 utilizing the system 100 to safeguard cold beer and wine in a cooler 200. The person places an identification document into the ID scanner 114 adjacent the cooler 200 and selects a particular cooler door 202 number to open. The local controller 108 and central controller 102 work together to perform the process of FIG. 6 and ultimately confirm at step 614 that the ID document is valid and that the user is not a known banned user. Thus, the local controller 108 automatically unlocks the selected cooler door 202 and the person is able to remove product 204.

In this example, the person is actually a bad actor and the ID presented was either their own driver's license or another person's stolen driver's license. The bad actor removes desired product 204 such as cold beer or wine and walks out of the store without paying. Staff in the vendor location notice this happening and follow the store's “no engage” policy to simply allow the person to exit with the product. The vendor's security team is then called immediately after the person has left the store.

The vendor security team utilizing the vendor management server 118 access both the security cameras and microphones at the vendor location and further view the access history log UI screen 700 for that vendor location via the central controller. They match up the date and time of the incident in order to identify the particular user information involved. Say, for example, the user information corresponds to the user “Mark S. Silvas” at Thursday, Feb. 14, 2022 at 14:34:23 in the example UI screen 700 of FIG. 7.

After identifying the user information, the security team personal ban the user by checking the “Theft” checkbox and pressing the “Ban” button for “Mark S. Silvas”. This user information is now associated with a banned user in the database 104. The security team further contact police and provide the information about the user along with the identification document document provided by the user to gain access. Although the document may be stolen, there is a chance that the bad actor used their own ID to gain access so this information may be helpful to police. Assuming the ID scanner 114 has a camera 210, the picture or video of the person along with other surveillance footage and audio taken in the store may also be provided to police as desired.

Continuing the same example, assume the bad actor then either returns to the same vendor location 110 or goes to another convenience store being a different vendor location 110 utilizing the system 100 to safeguard cold beer and wine in another cooler 200. This time, when the bad actor attempts to use the same identification document, even though the identification document will be determined as being valid (i.e., not fake), the central controller at step 608 will determine that the user information associated with this identification document corresponds to a known banned user. Access to the cooler 200 is therefore denied by the local controller at step 614. Furthermore, if the user has other identification documents for the same named person, these will also be found by the controller at step 608 to correspond with a known banned user. Thus, the bad actor will still be denied access. This is beneficial in the event that the bad actor tries using other identification documents belonging to the same person (either themselves, or the same person who's purse or wallet the bad actor stole, for example).

Beneficially, the system 100 can help facilitate police investigation and prosecution of theft by providing records of the identification documents and user information used by bad actors who gained access and then stole products or committed other offences at the store such as violence, abuse, etc. This increases the risk for bad actors and deters them from attempting the crime in the first place. Furthermore, repeated offences are prevented because, once a valid identification document for a certain person is used by a bad actor, the vendor security team can designate that person as a banned user and future attempts to gain access using valid identification documents of that same person will fail. It doesn't matter if the bad actor travels to a different convenience store (i.e., another vendor location 110) or if the bad actor uses a different valid identification document belonging to the same person. Overall security of the vendor locations 110 as a whole is thereby greatly increased by the access control system 100.

In an exemplary embodiment, an access control system includes identification document scanners installed at multiple vendor locations. A first local controller at a first vendor location by default controls one or more lock actuators to be in a locked configuration. An identification document scanner scans an identification document provided by a user at the first vendor location. The first local controller validates whether the identification document is authentic and passes user information obtained from the identification document to a central controller. The first local controller then controls one or more of the lock actuators to temporarily enter an unlocked configuration and thereby grant the user access to one or more products in response to determining that the identification document is authentic and receiving a ban status from a central controller indicating that the user is not banned for access. An access history log allows vendor staff to view access attempts and ban users.

Although the invention has been described in connection with preferred embodiments, it should be understood that various modifications, additions and alterations may be made to the invention by one skilled in the art without departing from the spirit and scope of the invention. For example, although the above-description has focused on convenience stores protecting drink product 204 such as cold beer and wine within a cooler 200, a similar system may be employed to product other types of products at other types of vendor locations 110. The lock actuators 114 may control locking of any door 202 or other type of product security means. For example, in another embodiment applied to a liquor store, the door 202 being secured may be the main door into the liquor store itself. However, unlike the situation described in the background section, under the system 100 described herein, the criminal cannot utilize their own valid photo ID or someone else's stolen ID in order to gain access to the store if that identification document is associated with a known banned user. Likewise, as soon as the bad actor utilizes someone's valid ID in order to commit a crime such as theft at one vendor location 110, they won't be able to enter any other liquor stores (i.e., any other vendor locations 110) to commit the same crime regardless of whether they use either the same identification document or a different identification document belonging to the same person.

Although the above UI screen 700 of FIG. 7 shows how vendor management and security team personal can ban a user after a crime is committed, there may be situations where a known banned user may need to be un-banned. Other UI screens or buttons to un-ban users may be implemented as needed for the purpose of unbanning users.

In some situations, the Internet 106 or other connection between the local controller 108 at a particular vendor location 110 and the central controller 102 may be temporarily severed. This may also occur if the central controller 102 goes down for maintenance or has a failure for some reason. In some embodiments, if the connection to central server 102 is severed then the decision of whether to unlock the door at step 614 is made by the local server 102 according to just the validity of the identification document presented by the user (i.e., just the result of step 604. Although this does lower the security of the vendor location 110, the affect is only temporary until the connection to the central controller 102 is restored. Still allowing access to the cooler 200 (or other product storage area) when valid ID is presented allows sales to be made like normal and avoids inconveniencing most customers who are not bad actors. A typical unsophisticated bad actor would not even be aware that the centrally managed banned user information is not being checked during times when the connection to the central controller 102 is unavailable.

Although a specific embodiment of the lock actuators 114 utilizing a linear actuator 300 and locking bolt 302 is shown in FIGS. 3 and 4, this is only one possible embodiment. There are many known variations of remote controllable lock actuators 114 available on the market and any of these other types of off-the-shelf lock actuators 114 may be utilized in place. Other types of custom-designed variations may also be used as desired according to application-specific requirements. In general, the lock actuator 114 simply needs to be remotely controllable by the local controller 108 such that access to one or more products for purchase can be selectively locked or unlocked under control of the local controller 108. Door-type lock actuators are one type of lock actuator 114. Other types include remotely controllable pad lock types, furniture lock types, rim latch lock types, switch lock types, lever handle lock types etc.

The above-described flowchart of FIG. 6 and associated functionality of the local controller 108 and central controller 102 may be implemented by software executed by one or more processors 500 operating pursuant to instructions stored on a tangible computer-readable medium such as a storage device 502 to perform the above-described functions of any or all aspects of the local and/or central controllers 108, 102 or ID scanner 112. Examples of the tangible computer-readable medium include optical media (e.g., CD-ROM, DVD discs), magnetic media (e.g., hard drives, diskettes), and other electronically readable media such as flash storage devices and memory devices (e.g., RAM, ROM). The computer-readable medium may be local to the computer executing the instructions, or may be remote to this computer such as when coupled to the computer via a computer network such as the Internet. The processors may be included in a general-purpose or specific-purpose computer that becomes the local/central controller 108, 102 or ID scanner 112 as a result of executing the instructions.

Although the above examples have described that the ID is scanned by the ID scanner 112 and then the local controller 108 passes user information obtained from the identification document to the central controller 102 to check with the central controller 102 to determine whether there is a ban, in other embodiments, the local controller 108 also has the ability to check for bans even if the local controller 108 and/or ID scanner units 112 are offline or otherwise without real-time access to the Internet 106. In some embodiments, the banned user database 104 and/or a portion thereof is downloaded (i.e., cached) to the local controller 108 and kept up to date while there is Internet access. For instance, a cached version of the banned user database may be stored in data 510 of local storage device(s) of the local controller 108 shown in FIG. 2. Then, if the local controller 108 goes offline, the local controller 108 can still check for bans by querying the downloaded cache copy in data 510. In some embodiments, the cached version is always queried by the local controller 108 regardless of Internet connectivity—the updates to the cached version occur in the background when the Internet connection is available and therefore it is always up to date.

Although the above examples have focused on paper documents for IDs, it is to be understood that a similar process as described above may also be performed for digital IDs as well. For example, the ID scanners 112 may include hardware to read digital IDs such as Apple® wallet utilizing NFC. These digital IDs may therefore be scanned by the ID scanner 112 reading one or more radio frequency or other signals detected from the card.

In other embodiments, rather than being software modules executed by one or more processors, the above-described functionality may be implemented as hardware modules configured to perform the above-described functions. Examples of hardware modules include combinations of logic gates, integrated circuits, field programmable gate arrays, and application specific integrated circuits, and other analog and digital circuit designs.

Functions of single modules may be separated into multiple units, or the functions of multiple modules may be combined into a single unit. For example, the central controller 102 may be integrated with a local controller 108 at a particular vendor location 110. In another example, the ID scanner 112 and local controller 108 may be integrated into a single device, or may be two separate devices. An example of when the ID scanner 114 and local controller 108 may be separate devices include situations where a single vendor location 110 has multiple different coolers 200 or other product storage containers that are physically distributed throughout the vendor location 110. A separate ID scanner 112 may be mounted adjacent each product container 200; however, all the ID scanners 112 may be coupled back to a single local controller 108, which may be installed in a server or computer area of the vendor location 110.

Unless otherwise specified, features described may be implemented in hardware or software according to different design requirements. In addition to a dedicated physical computing device, the word “server” may also mean a service daemon on a single computer, virtual computer, or shared physical computer or computers, for example. All combinations and permutations of the above described features and embodiments may be utilized in conjunction with the invention.

What is claimed is:

1. An access control system comprising:
an identification document scanner installed at a first vendor location;
one or more lock actuators installed at the first vendor location;
a first local controller installed at the first vendor location and coupled to the identification document scanner and the one or more lock actuators; and
a central controller coupled by an external computer network to a plurality of local controllers at a plurality of different vendor locations, the plurality of local controllers including the first local controller at the first vendor location;
wherein the first local controller by default controls the one or more lock actuators to be in a locked configuration;
the identification document scanner is configured to scan an identification document provided by a user at the first vendor location;
the first local controller is configured to validate whether the identification document is authentic and to pass user information obtained from the identification document to the central controller;
the central controller is configured to determine whether the user information corresponds to a known user who has been banned for access and to pass a ban status for the user back to the first local controller; and
the first local controller is configured to control one or more of the lock actuators to temporarily enter an unlocked configuration and thereby grant the user access to one or more products secured by the one or more of the lock actuators in response to determining that the identification document is authentic and receiving the ban status from the central controller indicating that the user is not banned for access.

2. The access control system of claim 1, wherein, in a situation that the first local controller has lost communication with the central controller, the first local controller is configured to control the one or more lock actuators to temporarily enter the unlocked configuration solely in response to determining that the identification document is authentic.

3. The access control system of claim 1, wherein:
the first local controller caches at least a part of a banned user database downloaded from the central server as a cached version of the banned user database; and
in a situation that the first local controller has lost communication with the central controller, the first local controller is configured to determine whether the user information corresponds to a known user who has been banned for access by querying the cached version of the banned user database.

4. The access control system of claim 1, further comprising:
a second identification document scanner installed at a second vendor location;
one or more second lock actuators installed at the second vendor location; and
a second local controller installed at the second vendor location and coupled to the second identification document scanner and the one or more second door lock actuators.

5. The access control system of claim 1, wherein the central controller is configured to store an access history log of the first vendor location in one or more storage devices, the access history log including a plurality of user information associated with a plurality of users who were granted access by the first local controller at the first vendor location.

6. The access control system of claim 5, wherein the central controller is configured to:
allow an administrator to view the access history log of the first vendor location;
receive a ban user command from the administrator, the ban user command indicating a particular user who was granted access at the first vendor location according to the access history log; and
after receiving the ban user command, store a record of the particular user as a new known user who has been banned for access, and pass a new ban status indicating the particular user is banned for access in response to receiving, in one or more future requests, user information associated with the particular user obtained from any identification document of the particular user and received from any of the plurality of local controllers at the different vendor locations.

7. The access control system of claim 1, wherein, after controlling the one or more lock actuators to enter the unlocked configuration, the first local controller is configured to automatically control the one or more lock actuators to return to the locked configuration after a predetermined access duration.

8. The access control system of claim 7, further comprising:
one or more sensors on one or more doors respectively locked and unlocked by the plurality of lock actuators, the one or more sensors to determine whether each of the one or more doors are open or closed;
wherein the first local controller is configured to only measure the predetermined access duration while the one or more doors are determined to be closed.

9. The access control system of claim 1, further comprising:
a user interface display coupled to the first local controller;
wherein, in response to determining that the identification document is not authentic or receiving the ban status from the central controller indicating that the user is banned for access, the first local controller is configured to display an error message to the user on the user interface display.

10. The access control system of claim 1, further comprising:
a user interface coupled to the first local controller;
wherein the one or more lock actuators comprise a plurality of door lock actuators installed on a plurality of corresponding doors;
the first local controller is configured to receive a selection of a particular one of the corresponding doors to unlock from the user via the user interface; and
in response to determining that the identification document is authentic and receiving the ban status from the central controller indicating that the user is not banned for access, the first local controller is configured to control a particular one of door lock actuators to thereby unlock the particular one of the corresponding doors selected by the user.

11. A local controller installed at a first vendor location, the local controller comprising:
one or more communication interfaces for coupling to an identification document scanner installed at the first vendor location, one or more lock actuators installed at the first vendor location, and a central controller coupled to the local controller by an external computer network;
one or more storage devices; and
one or more processors coupled to the one or more communication interface and the one or more storage devices;
wherein, by the one or more processors executing a plurality of software instructions loaded from the one or more storage devices, the one or more processors are configured to:
by default, control the one or more lock actuators to be in a locked configuration;
receive scan data from the identification document scanner of a scan of an identification document provided by a user;
validate whether the identification document is authentic;
pass one or more user information obtained from the identification document to the central controller;
receive a ban status for the user back to the first local controller, the ban status indicating whether the user information corresponds to a known user who is banned for access; and
control one or more of the lock actuators to temporarily enter an unlocked configuration and thereby grant the user access to one or more products secured by the one or more of the lock actuators in response to determining that the identification document is authentic and receiving the ban status from the central controller indicating that the user is not banned for access.

12. The local controller of claim 11, wherein, in a situation that the one or more processors have lost communication with the central controller, the one or more processors are configured to control the one or more of the lock actuators to temporarily enter the unlocked configuration solely in response to determining that the identification document is authentic.

13. The local controller of claim 11, wherein the one or more processors are further configured to:
cache at least a part of a banned user database downloaded from the central server as a cached version of the banned user database; and
in a situation that the first local controller has lost communication with the central controller, determine whether the user information corresponds to a known user who has been banned for access by querying the cached version of the banned user database.

14. The local controller of claim 11, wherein, after controlling the one or more of the lock actuators to enter the unlocked configuration, the one or more processors are configured to automatically control the one or more of the lock actuators to return to the locked configuration after a predetermined access duration.

15. The local controller of claim 14, wherein:
the one or more communication interfaces are further coupled to one or more sensors on one or more doors respectively locked and unlocked by the plurality of lock actuators, the one or more sensors to determine whether each of the one or more doors are open or closed; and
the one or more processors are configured to only measure the predetermined access duration while the one or more doors are determined to be closed.

16. The local controller of claim 11, wherein:
the one or more communication interfaces are further coupled to a user interface display; and
in response to determining that the identification document is not authentic or receiving the ban status from the central controller indicating that the user is banned for access, the one or more processors are configured to display an error message to the user on the user interface display.

17. The local controller of claim 11, wherein:
the one or more communication interfaces are further coupled to a user interface coupled to the first local controller;
the one or more lock actuators comprise a plurality of door lock actuators installed on a plurality of corresponding doors;
the one or more processors are configured to receive a selection of a particular one of the corresponding doors to unlock from the user via the user interface; and
in response to determining that the identification document is authentic and receiving the ban status from the central controller indicating that the user is not banned for access, the one or more processors are configured to control a particular one of door lock actuators to thereby unlock the particular one of the corresponding doors selected by the user.

18. A method of performing access control at a first vendor location, the first vendor location having installed thereat an identification document scanner, one or more lock actuators, and a first local controller being coupled to the identification document scanner and the one or more lock actuators, the method comprising:
by default, controlling the one or more lock actuators to be in a locked configuration;
scanning, by the identification document scanner, an identification document provided by a user at the first vendor location;
validating, by the first local controller, whether the identification document is authentic;
passing user information obtained from the identification document to a central controller, the central controller being coupled by an external computer network to a plurality of local controllers at a plurality of different vendor locations, the plurality of local controllers including the first local controller at the first vendor location;
determining, by the central controller, whether the user information corresponds to a known user who has been banned for access and passing a ban status for the user back from the central controller to the first local controller; and
controlling, by the first local controller, one or more of the lock actuators to temporarily enter an unlocked configuration and thereby grant the user access to one or more products secured by the one or more of the lock actuators in response to determining that the identification document is authentic and receiving the ban status from the central controller indicating that the user is not banned for access.

19. The method of claim 18, further comprising:
storing, by the central controller, an access history log of the first vendor location in one or more storage devices, the access history log including a plurality of user information associated with a plurality of users who were granted access by the first local controller at the first vendor location;
allowing an administrator to view the access history log of the first vendor location;
receiving a ban user command from the administrator, the ban user command indicating a particular user who was granted access at the first vendor location according to the access history log; and
after receiving the ban user command, storing by the central controller a record of the particular user as a new known user who has been banned for access, and passing a new ban status indicating the particular user is banned for access in response to receiving, in more or future requests, user information associated with the particular user obtained from any identification document of the particular user and received from any of the plurality of local controllers at the different vendor locations.

20. The method of claim 18, wherein:
the one or more lock actuators comprise a plurality of door lock actuators installed on a plurality of corresponding doors;
the method further includes receive a selection of a particular one of the corresponding doors to unlock from the user via a user interface; and
in response to determining that the identification document is authentic and receiving the ban status from the central controller indicating that the user is not banned for access, controlling a particular one of door lock actuators to thereby unlock the particular one of the corresponding doors selected by the user.
